(19) United States
(12) Patent Application Publication
(10) Pub. No.: US 2007/0183598 A1
(43) Pub. Date: Aug. 9, 2007

(54) Apparatus for managing DRM installation and method thereof

(75) Inventors: Hwan-joon Kim, Yongin-si (KR); Weon-il Jin, Yongin-si (KR); Eun-sun Jung, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/648,672

(22) Filed: Jan. 3, 2007

(30) Foreign Application Priority Data
Jan. 26, 2006 (KR) 2006-08576

(51) Int. Cl. H04L 9/00

(52) U.S. Cl. 380/277

(57) ABSTRACT

Provided is a DRM installation management device and method, which requests secret DRM from a DRM Center in order to use DRM that is necessary to access content, receives the requested secret DRM and installs the DRM, and is able to implement authentication and decryption using the secret DRM. Even if DRM related to digital content stored on the device is not present, DRM for the relevant digital content can be automatically downloaded and installed. Moreover, using the public key certificates and private keys, security problems relating to secret DRM are overcome.

### CROSS-REFERENCE TO RELATED APPLICATION

This application claims the benefit under 35 U.S.C. §119(a) of Korean Patent Application No. 2006-08576 filed on Jan. 26, 2006, in the Korean Intellectual Property Office, the entire disclosure of which is hereby incorporated by reference.

### BACKGROUND OF THE INVENTION

1. Field of the Invention

The present invention relates to an apparatus for managing the installation of Digital Rights Management (DRM) and the method thereof. More particularly, the present invention relates to an apparatus for managing the installation of DRM and the method thereof, in which a request can be made to the DRM Center for secret DRM in order to use the DRM that is necessary for accessing content, transmitting the requested secret DRM and installing the relevant DRM, and thereby implement authentication and decryption of the DRM.

2. Description of the Prior Art

DRM is a way of guaranteeing the safe distribution of paid content through the Internet. DRM is one type of server software that has been developed to prevent illegal distribution. DRM technology is continuing to be developed as a means to increase the protection of commercial rights on the Internet. DRM technology is needed to overcome the widespread use of file-sharing programs among users. Although online content is protected by copyright law, controlling illegal Internet use and arresting offenders is very difficult.

DRM technology shifts the focus from apprehending the offenders after the crime has taken place to preventing the crime. The approach of preventing the crime is a more definite resolution to the problem of protecting online rights. Many companies are introducing various kinds of DRM products using a number of different approaches and techniques.

DRM installation in most DRM technologies takes place at the production stage. DRM may also be installed over the Internet through a network, but the DRM installer used by each company is different.

By way of example, if DRM “B” is installed on a device on which the user uses a product from company “B”, and content “a” protected by DRM “A”, which is not installed, is downloaded from the Internet, DRM “A” is required in order to access content “a”. In this situation, DRM “A” can only be used on a device using a product from company “A”, and DRM “B” can only be used on a device using a product from company “B”. As a result, the user in the example is unable to access content “a” protected by DRM “A”.

In order to access content “a” protected by DRM “A”, the user is forced to purchase the product of company “A”, which is able to use DRM “A”.

Secret information that needs to be stored safely at the time of the initial DRM installation is referred to as “secret DRM”. Secret DRM is personal information that is generally protected by a Content Encryption Key (CEK).

However, various security problems concerning secret DRM arise at or after the time of conventional DRM installation, have not been resolved.

Accordingly, there is a need for improved Digital Rights Management (DRM) that overcomes the problems associated with secret DRM that arise at or after the time of conventional DRM installation.

### SUMMARY OF THE INVENTION

Exemplary embodiments of the present invention address at least the above problems and/or disadvantages and provide at least the advantages described below. Accordingly, an aspect of the present invention is to provide a Digital Rights Management (DRM) installation management method and apparatus that is capable of requesting secret DRM from the DRM Center in order to use DRM that is necessary to access content, transmitting the requested secret DRM and installing the relevant DRM, and using the installed DRM to implement DRM authentication and decryption.

A DRM installation management apparatus according to an exemplary embodiment of the present invention, for use in a DRM installation management system with a Trusted Platform Center (TPC) server, Unified DRM installer Trust Manager (UTM) server, and a DRM Center server. The DRM installation management apparatus comprises a Unified DRM Mediator, which sends a request to the DRM server for the secret DRM necessary for DRM installation and authentication if the DRM of the digital content is not present on the device, verifies the signature file of the UTM server added to the secret DRM transmitted from the DRM Center server in response to the request, and transmits the secret DRM after verification; and a Trusted Platform Module (TPM) which receives the secret DRM from the Unified DRM Mediator, verifies the signature file of the TPC server which is added to the transmitted secret DRM, decrypts the secret DRM after verification, and uses the decrypted secret DRM in installing DRM.

The TPM additionally prevents changes to the TPM public key certificate and the TPC private key (PK) in the secret DRM, and implements the function of installing the DRM.

The TPM parses and stores the TPM public key certificate and the TPC private key (PK).

The DRM Center server confirms the legitimacy of the request for the secret DRM through the TPC server providing a TPM public key certificate and a TPC private key, and the UTM server providing a UTM private key (PK).

The TPM stores a TPM public key certificate and a TPC private key (PK), and further comprises a Unified DRM Storage Section, which stores a TPC public key certificate and TPM public key certificate, a UTM public key certificate, and a TPM private key (PK).

The Unified DRM Mediator transmits a secret DRM request message comprising a TPM_ID, a UDi private key and a TPM private key to the DRM server.

Another DRM installation management apparatus according to the aims of an exemplary embodiment of the present invention, in a system with a TPC server, a UTM server, and a DRM Center server, comprises a Unified DRM Mediator which makes a request from the server for the secret DRM necessary for installation and authentication of DRM in the situation that DRM of the digital content is not present, and transmits the secret DRM from the DRM Center server in response to the request; and a Trusted Platform Module (TPM) which implements authentication of a UTM private key and a TPC private key (PK) in the secret DRM transmitted from the Unified DRM Mediator, and implements decryption of the TPM public key certificate.

Here, the TPM implements the function of preventing changes in the TPM public key certificate and the TPC private key, and implements the DRM installation function.

The TPM stores the UTM private key, the TPM public key and the TPC private key.

Additionally, the TPM stores the TPM public key certificate, the UTM private key and the TPC private key (PK), and further comprises a Unified DRM Storage which stores the TPC public key certificate, the TPM public key certificate, the UTM public key certificate, and the TPM private key certificate.

A DRM installation management method according to the aims of an exemplary embodiment of the present invention, in a system with a TPC server, a UTM server, and a DRM Center server, comprises: (a) requesting secret DRM necessary for DRM installation and authentication from the DRM server in the situation that no digital content DRM is present; (b) verifying the signature file of the UTM server added to the secret DRM transmitted by the DRM Center in response to the request, and transmitting the secret DRM after verification; and (c) installing the DRM, by verifying the signature file of the TPC server added to the transmitted secret DRM, decrypting the secret DRM after verification, and using the secret DRM in DRM installation.

In the secret DRM request step, the requested message comprising a TPM ID, and a UDi secret DRM and a TPM private key are transmitted to the DRM Center server.

After the secret DRM request step, the DRM server confirms the legitimacy of the request for the secret DRM, using the TPC server, which provides the TPM public key and the TPC private key, and the UTM server, which provides the UTM private key.

The DRM installation step is implemented after the TPM public key and TPC private key have been parsed and saved.

Another DRM installation management method according to the aims of-an exemplary embodiment of the present invention, in a system with a Trusted Platform Center (TRC) Server, a Unified DRM Installation Management (UTM) Server and a DRM Center server, comprises (a) requesting secret DRM necessary for DRM installation and confirmation from the DRM Center server in the situation that DRM of digital content is not present; (b) transmitting secret DRM from the DRM Center server in response to the request; and (c) installing DRM by implementing authentication based on a UTM private key and a TPC private key in the transmitted secret DRM, and implementing decryption based on a TPM public key certificate.

In step (a) a secret DRM request message comprising a TPM ID, a UDi private key and a TPM private key is transmitted to the DRM server.

After step (a), the DRM Center server confirms the legitimacy of the request for the secret DRM using the TPC Server providing the TPM public key and the TPC private key, and the UTM server providing the UTM private key.

Step (c) is implemented after the UTM private key and the TPM public key and the TPC private key are parsed and stored.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram schematically displaying the composition of the DRM installation management system in an exemplary embodiment of the present invention,

FIG. 2 is a block diagram displaying the internal composition of the device,

FIG. 3 is a flow chart explaining the DRM installation management method in the first exemplary embodiment of the present invention, and

FIG. 4 is a flow chart explaining the DRM installation management method in the second exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Although the DRM of each device from each company is typically different, exemplary embodiments of the present invention are designed to install on a device and use DRM from companies other than the company that produced the device, and also to resolve security problems of the secret DRM.

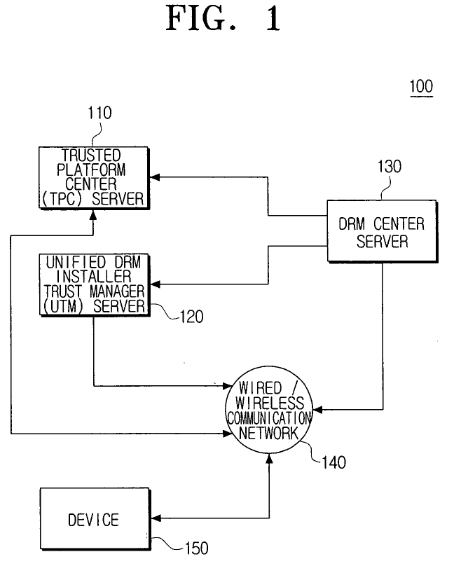

FIG. 1 is a block diagram schematically showing the composition of the DRM installation management system according to an exemplary embodiment of the present invention.

The DRM installation management system 100 in this an exemplary embodiment of the present invention comprises a Trusted Platform Center (TPC) Server 110, a Unified DRM installer Trust Manager (UTM) Server 120, a DRM Center server 130, a wired or wireless-communication network 140, and a device 150.

The TPC server 110 stores a TPC private key internally, implements authentication of the TPM private key in a secret DRM transmitted from the DRM Center server 130, and transmits a TPM public key signed with its own TPC private key to the DRM Center server 130. The secret DRM is information which must be securely stored at the time of the initial DRM installation, and can comprise public keys, private keys, and other keys.

The UTM server 120 stores a UTM private key internally, and implements authentication of a UTM public key in the secret DRM transmitted from the DRM Center server 130, signs the secret DRM with its own UTM private key, and transmits the UTM private key and the TPC private key to the DRM Center server 130.

The DRM Center server 130 transmits the secret DRM request message comprised in a TPM_ID, UTM public key and the TPM public key to the TPC server 110 and the UTM server 120 in order to confirm the legitimacy of the secret DRM request transmitted from the device 150. Additionally, when the process of authentication from the TPC server 110 and UTM server 120 is finished, if the legitimacy of the secret DRM is confirmed, the DRM Center server 130 transmits the secret DRM comprising the TPM public key, TPC private key and the UTM private key to the device 150.

The wired/wireless communication network 140 provides a connection between the device 150 and the DRM Center server 130 by wired or wireless means.

The device 150 stores the TPC public key, the TPM public key, the UTM public key, and the TPM private key. When the user wishes to access content protected by DRM that is not installed, the device 150 sends a request for the secret DRM to the DRM Center server 130. At this time, the device 150 sends a secret DRM request message comprising the TPM_ID, UDi private key, and the TPM private key to the DRM Center server 130. Additionally, the device 150 implements encryption/decryption using the TPM public key certificate in the secret DRM transmitted from the DRM Center server 130.

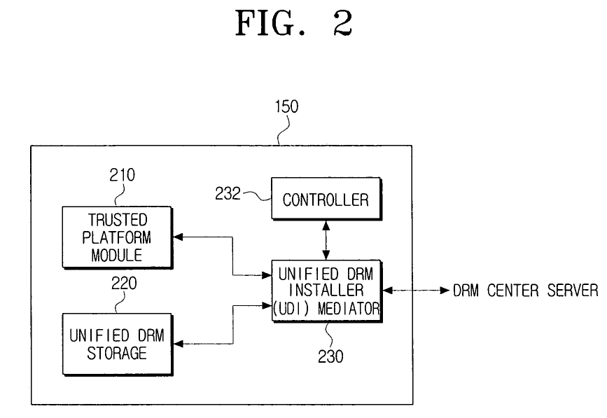

FIG. 2 is a block diagram showing the internal composition of the device.

The device 150 comprises a Trusted Platform Module (TPM) 210, a Unified DRM Storage 220, a Unified DRM installer Mediator (UDi) 230, and a controller 232.

The TPM 210 stores the secret DRM, transmitted from the DRM Center server 130 through the UDi Mediator 230, in the Unified DRM Storage 220. The TPM 210 implements authentication using the TPC private key in the secret DRM transmitted from the UDi Mediator 230, and implements decryption using the TPM public certificate. Authentication and encryption/decryption using the secret DRM is known as computation of the DRM.

The TPM 210 implements tamper resistance, preventing changes to the TPM public key certificate and the TPC private key. Additionally, the TPM 210 parses and stores the secret DRM as a TPM public key certificate and a TPC private key, and implements a Cryptographic Engine function and installs the relevant DRM.

The Unified DRM Storage 220 stores the TPM_ID, the TPC public key certificate, the UTM public key certificate, the secret TPM keys, and the TPC information. Here, the secret TPM keys comprise the TPM public key certificate and the TPM private key.

The UDi Mediator 230 comprises a UDi private key and UDi public key certificate, and transmits the secret DRM request message comprising the TPM_ID, UDi private key and the TPM private key safely to the DRM Center server 130. The UDi Mediator 230 implements authentication based on the UTM private key in the secret DRM received from the DRM Center server 130. Additionally, the UDi Mediator 230 transmits the remaining TPC private key and the TPM public key in the received secret DRM to the TPM 210.

The controller 232 controls all actions of the device, and controls the playback of digital content. Moreover, if the DRM of the digital content is not installed, the controller 232 communicates with the DRM Center server 130 through the TPM 210 and the UDi Mediator 230, and makes it possible to receive the secret DRM necessary to use the digital content. Additionally, the controller 232 installs the relevant DRM using the received secret DRM, making it possible to access the digital content.

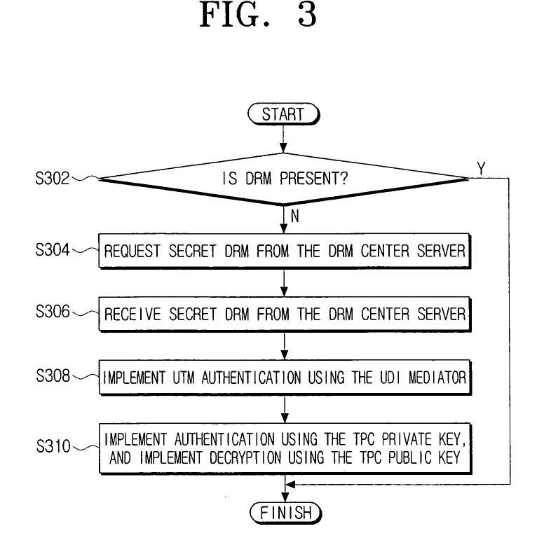

FIG. 3 is a flow chart explaining the DRM installation management method in the first exemplary embodiment of the present invention.

Firstly, in S302 the device 150 is able to download and store digital content from the DRM Center server 130 through the wired/wireless communication network 140. At this time, the device 150 determines whether or not DRM comprising secret DRM is installed.

In S304, if the DRM required to access digital content downloaded and stored on the device 150 is not installed, the device 150 sends a request to the DRM Center server 130 for the secret DRM necessary to access the content.

The UDi Mediator 230 transmits the secret DRM request message comprising the TPM_ID, the UDi private key and the TPM private key from the device 150 to the DRM Center server 130.

The DRM Center server 130 transmits the secret DRM request message to the TPC server 110 and UTM server 120 in order to confirm the legitimacy of the secret DRM request message received from the device 150.

The TPC server 110 implements authentication using the UDi private key and the TPM private key, based on the TPM_ID and the TPC private key in the received secret DRM request message, confirms the legitimacy of the user, and after signing using the TPC private key, transmits the response data comprising the TPM public certificate and the TPC private key to the DRM Center server 130.

The UTM server 120 confirms the legitimacy of the user using the UDi private key in the received secret DRM request message, and after signing with the UTM private key, transmits the response data comprising the UTM private key to the DRM Center server 130.

The DRM Center server 130 transmits the secret DRM, comprising the TPM private key certificate and the TPC private key received from the TPC server 110, and the UTM private key received from the UTM server 130, to the device 150.

Accordingly, in S306, the device 150 receives the secret DRM comprising the TPM public key certificate, the TPC private key and the UTM private key from the DRM Center server 130.

In S308, the device 150 implements UTM authentication based on the UTM private key in the secret DRM using the UDi Mediator 230. The UDi Mediator 230 implements the DRM computation for authentication using the UDi private key regarding the UTM private key, that is needed for unified DRM management, in the secret DRM received from the DRM Center server 130. Moreover, the UDi Mediator 230 safely transmits the remaining secret DRM, that is, the TPM public key certificate and the TPC private key, to the TPM 210.

In S310, the device 150 stores the TPM public key certificate and the TPC private key in the Unified DRM Storage 220 using the TPM 210, and then implements authentication required for the DRM based on the TPC private key, and implements decryption based on the TPC public key certificate.

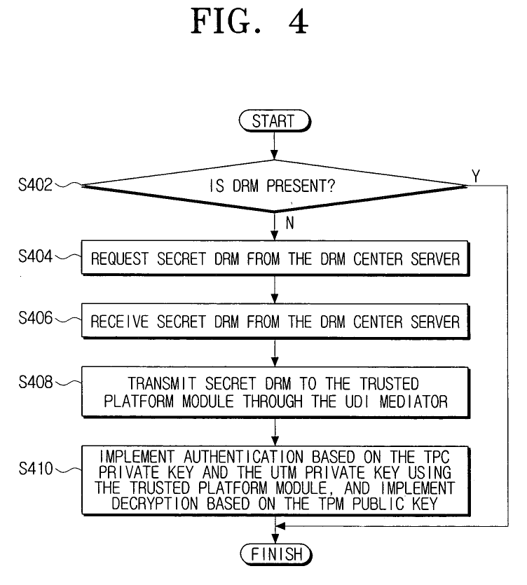

FIG. 4 is a flow chart explaining the DRM installation management method according to the second exemplary embodiment of the present invention.

The device 150 is able to receive and store digital content from the DRM Center server 130 through the wired/wireless communications network 140, and in S402, evaluates whether or not DRM comprising secret DRM is installed on the device 150.

In S404, if DRM required to access the currently stored content is not installed, the device 150 makes a request to the DRM Center server 130 for the secret DRM necessary to use the digital content.

The device 150 transmits the secret DRM request message comprising the TPM_ID, the UDi private key, and the TPM private key to the DRM Center server 130 through the UDi Mediator 230.

The DRM Center server 130 transmits the secret DRM request message to the TPC server 110 and the UTM server 120 in order to confirm the legitimacy of the secret DRM request message received from the device 150.

The TPC server 110 confirms the legitimacy of the user based on the TPM_ID and the TPM private key in the received secret DRM request message, and after signing using the TPC private key, transmits the response data comprising the TPM public key certificate and the TPC private key to the DRM Center server 130.

The UTM server 120 confirms the legitimacy of the user using the UDi private key in the received secret DRM request message, and after signing with the UTM private key, transmits the response data comprising the UTM private key to the DRM Center server 130.

The DRM Center server 130 transmits the secret DRM, comprising the TPM public key certificate and the TPC private key received from the TPC server 110, and the UTM private key from the UTM server 120, to the device 150.

In S406, the device 150 receives the secret DRM comprising the TPM public key certificate, the TPC private key and the UTM private key from the DRM Center server 130.

In S408, the UDi Mediator 230 of the device 150 safely transmits the secret DRM comprising the TPM public key certificate, the TPC private key, and the UTM private key to the TPM 210.

In S410, the device 150 stores the UTM private key, the TPM public key certificate and the TPC private key in the Unified DRM Storage 220 using the TPM 210, and after this implements authentication based on the UTM private key and the TPC private key, and implements decryption that is necessary for the DRM based on the TPM public key certificate.

Exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains.

According to the exemplary embodiments of the present invention as described above, even if the DRM required to access digital content stored in the device is not present, the needed DRM can be installed and used. Further, the security problems of secret DRM can be resolved using the public keys and private keys.

While certain exemplary embodiments of the invention has have been shown and described hereinwith reference to a certain preferred embodiments thereof, it will be understood by those skilled in the art that various changes in form and details may be made therein without departing from the spirit and scope of the invention as defined by the appended claims and their equivalents.

What is claimed is:

1. A Digital Rights Management (DRM) installation management apparatus, for use in a system comprising a Trusted Platform Center (TPC) server, a Unified DRM installer Trust Manager (UTM) server, and a DRM Center server; comprising:
a unified DRM mediator for requesting a secret DRM necessary for installing and authenticating DRM from the DRM Center server if DRM is not present, verifying a signature file of the UTM server added to the secret DRM received from the DRM Center server following the request, and transmitting the DRM after verification; and
a Trusted Platform Module (TPM) for receiving the secret DRM from the Unified DRM Mediator, implementing verification of the TPM server added to the received secret DRM, decrypting the secret DRM according to the authentication, and using the decrypted secret DRM in installing the DRM.

2. A DRM installation management apparatus according to claim 1, wherein
the TPM prevents changes to a TPM public key certificate and a TPC private key in the secret DRM, and installs the DRM.

3. A DRM installation management apparatus according to claim 2, wherein
the TPM parses and stores the TPM public key certificate and the TPC private key.

4. A DRM installation management apparatus according to claim 1, wherein
the DRM Center server confirms if the request for secret DRM is legitimate using the TPC server, which provides a TPM public key certificate and a TPC private key, and the UTM server, which provides a UTM private key.

5. A DRM installation management apparatus according to claim 2, wherein
the TPM stores the TPM public key certificate and the TPC private key, and further comprises
a Unified DRM Storage, which stores a TPC public key certificate, the TPM public key certificate, a UTM public key certificate and a UTM private key.

6. A DRM installation management apparatus according to claim 1, wherein
the Unified DRM Mediator transmits the secret DRM request message comprising a TPM_ID, a UDi private key, and a TPM private key to the DRM Center server.

7. A DRM installation management apparatus, for use in a system comprising a Trusted Platform Center (TPC) server, a Unified DRM installer Trust Manager (UTM) server, and a DRM Center server, comprising:
a Unified DRM Mediator for requesting secret DRM necessary for installing and authenticating the DRM if DRM is not present, and receiving and transmitting the secret DRM from the DRM Center server; and
a Trusted Platform Module (TPM) for authenticating based on a UTM private key and a TPC private key in the secret DRM transmitted by the Unified DRM Mediator, and decrypting based on a TPM public key certificate.

8. A DRM installation management apparatus according to claim 7, wherein
the TPM prevents changes to the TPM public key certificate and the TPC private key, and installs the DRM.

9. A DRM installation management apparatus according to claim 7, wherein
the TPM stores the UTM private key, the TPM public key and the TPC private key.

10. A DRM installation management apparatus according to claim 7, which stores the TPM public key certificate, the UTM private key and the TPC private key, and further comprises
a Unified DRM Storage storing the TPM public key certificate, the TPM public key certificate, the UTM public key certificate, and the TPM private key.

11. A DRM installation management method for use in a system comprising a Trusted Platform Center (TPC) server, a Unified DRM installer Trust Manager (UTM) server and a DRM Center server, comprising:
(a) requesting secret DRM that is necessary for installing and authenticating DRM from the DRM Center server, if DRM that is necessary to access digital content is not present;
(b) verifying the signature file of the UTM server which is added to the secret DRM received from the DRM Center server in step (a), and transmitting the secret DRM after verification; and
(c) installing the DRM by verifying the signature file of the TPM server added to the transmitted secret DRM, and decrypting the secret DRM after verification of the signature file.

12. A DRM installation management method according to claim 11, wherein
the secret DRM request message transmitted to the DRM Center server in step (a) comprises a TPM_ID, a UDi private key, and a TPM private key.

13. A DRM installation management method according to claim 11, wherein
after step (a), the DRM Center server confirms whether or not the secret DRM request message is legitimate, using the TPC server, which provides a TPM public key and a TPC private key, and the UTM server, which provides a UTM secret key.

14. A DRM installation management method according to claim 11, wherein
step (c) is implemented after parsing and storing a TPM public key and a TPC private key.

15. A DRM installation management method for use in a system comprising a Trusted Platform Center (TPC) server, a Unified DRM installer Trust Manager (UTM) server, and a DRM Center server, comprising:
(a) requesting secret DRM that is necessary for installing and authenticating DRM from the DRM Center server, if DRM that is necessary to access digital content is not present;
(b) receiving secret DRM transmitted from the DRM Center server; and
(c) installing DRM by implementing authentication based on a UTM private key and a TPC private key in the transferred secret DRM, and implementing decryption based on a TPM public key certificate.

16. A DRM installation management method according to claim 15, wherein
the secret DRM request message transmitted to the DRM Center server in step (a) comprises a TPM_ID, a UDi private key, and a TPM private key.

17. A DRM installation management method according to claim 15, wherein
after step (a), the DRM Center server confirms whether or not the secret DRM request message is legitimate, using the TPC server, which provides the TPM public key and the TPC private key, and the UTM server, which provides the UTM secret key.

18. A DRM installation management method according to claim 15, wherein
step (c) is implemented after parsing and storing the UTM private key, the TPM public key and the TPC private key.

19. A computer-readable medium having embodied thereon a computer program for a method of managing DRM installation, for use in a system comprising a Trusted Platform Center (TPC) server, a Unified DRM installer Trust Manager (UTM) server and a DRM Center server, the method comprising:
(a) requesting secret DRM that is necessary for installing and authenticating DRM from the DRM Center server, if DRM that is necessary to access digital content is not present;
(b) verifying the signature file of the UTM server which is added to the secret DRM received from the DRM Center server in step (a), and transmitting the secret DRM after verification; and
(c) installing the DRM by verifying the signature file of the TPM server added to the transmitted secret DRM, and decrypting the secret DRM after verification of the signature file.

20. A computer-readable medium having embodied thereon a computer program for a method of managing DRM installation, for use in a system comprising a Trusted Platform Center (TPC) server, a Unified DRM installer Trust Manager (UTM) server and a DRM Center server, the method comprising:
(a) requesting secret DRM that is necessary for installing and authenticating DRM from the DRM Center server, if DRM that is necessary to access digital content is not present;
(b) receiving secret DRM transmitted from the DRM Center server; and
(c) installing DRM by implementing authentication based on a UTM private key and a TPC private key in the transferred secret DRM, and implementing decryption based on a TPM public key certificate.
